(19) United States
(12) Patent Application Publication
(10) Pub. No.: US 2023/0030309 A1
(43) Pub. Date: Feb. 2, 2023

(54) VEHICLE PRICE NEGOTIATION APPLICATION AND AGENT

(71) Applicants: Elias Christeas, Sarasota, FL (US); Peter Fray, Osprey, FL (US)

(72) Inventors: Elias Christeas, Sarasota, FL (US); Peter Fray, Osprey, FL (US)

(21) Appl. No.: 17/392,159

(22) Filed: Aug. 2, 2021

(51) Int. Cl. G06Q 30/08; G06Q 30/02; G06N 20/00

(52) U.S. Cl. CPC G06Q 30/08; G06N 20/00; G06Q 30/0283

(57) ABSTRACT

A novel cloud-based system is provided comprising at least one or more servers and databases for negotiating a price among competitive sellers for consumer articles such as automobiles whereby a user is provided access to a consumer article price negotiation system and negotiation application such that the price negotiation is conducted by and through a negotiation assistant (i.e., an artificial intelligence agent) that exchanges communications and negotiates, on behalf of but independent from the user, with a variety of vehicle dealerships desiring to fulfill the sale request.

### FIELD OF THE INVENTION

The present invention relates generally to consumer pricing and purchasing applications, and more particularly, to a method and application that facilitate identifying available competitive pricing on an article of commerce and improving the overall buying experience.

### BACKGROUND OF THE INVENTION

Purchasing a new or used vehicle is a major decision and transaction for an individual consumer. In the automobile industry, consumers typically purchase automobiles from a car dealership affiliated with a particular brand (e.g. Ford, Chevrolet, etc.) and through a negotiation process with an on-site salesperson. Of course, the consumer desires to negotiate the lowest possible price for the vehicle that is below the so-called manufacturer suggested retail price (i.e., the “sticker price”) and the salesperson desires to negotiate the highest possible sale price thereby maximizing their individual sales commission and dealership profit. Given this dynamic, the negotiation process typically involves a high degree of uncertainty for the consumer and a certain lack of trust. Indeed, the car buying experience can be for many people a very unpleasant experience and particularly for those individuals who are nervous of sales pressure.

Typically, the consumer may have legitimate concerns that the dealer may not be offering them a fair and competitive price on their vehicle of choice and trying to take advantage of the potentially imbalanced negotiation positions between buyer and seller. Various products and services are available to assist the consumer in researching market prices for automobiles in a general way and also specific to their geographical marketplace. Similarly, dealers utilize various products and services to track real-time market prices and the automobile manufacturers also have an interest therein because the capturing of real-time market pricing will allow for instant profitability determinations, identifying which automobiles are “hot” in the marketplace and whether manufacturer incentives should be offered to dealers to stimulate sales activity on existing dealer inventory.

In the current Internet era, there exist a plethora of on-line tools such as CARFAX, Kelly Blue Book, Edmunds, and TrueCar, to name just a few that a consumer may access to research vehicle configurations and associated pricing. These on-line tools allow for research into invoice pricing, comparison of new car deals being offered, determining available dealer incentives, available car inventories, safety features, model reliability and basically every material element of the car buying experience. In a nutshell, the advantages of these on-line tools help educate the consumer and arm them with valuable data and information as they enter a dealership to negotiate the purchase price of their desired vehicle.

However, despite their many advantages these on-line tools fail to guarantee that a consumer will receive the best price on their purchased vehicle, do not actively promote competition among dealers competing for an individual consumer’s business, do not participate in negotiating the individual’s sales transaction and may not fully capture important data points such as dealership sales quotas, incentives and rebates that are only known to the individual dealership in real-time and at the time of the sales negotiation.

Accordingly, there is need for a solution providing a technique that improves the overall consumer buying experience and facilitates identification of the best available pricing at for consumer articles.

### SUMMARY OF THE INVENTION

The present invention is directed to a system, apparatus and method for negotiating a price on behalf of a consumer among competitive sellers for consumer articles such as automobiles.

In a first implementation of the invention, a cloud-based system is provided employing a cloud-based system comprising at least one or more servers and databases for negotiating a price on behalf of a consumer (or user) among competitive sellers for consumer articles such as automobiles. A user is provided with a consumer article price negotiation system and negotiation tool such that the price negotiation is conducted by and through a negotiation assistant (i.e., an artificial intelligence agent) that exchanges communications, and independent from the user, with a variety of vehicle dealerships desiring to fulfill the sale request. More particularly, the consumer article price negotiation system comprises: an information delivery and negotiation exchange cloud comprising one or more servers and one or more databases, the information delivery and negotiation exchange cloud being accessible by a plurality of dealers, and the one or more first databases storing information associated with a consumer article price negotiation, and wherein the consumer article is a vehicle in an embodiment. A user device is further provided comprising: a processor; and a memory storing instructions that when executed cause the processor to perform operations comprising: collecting vehicle purchasing and configuration information, a plurality of user-defined negotiation parameters and a plurality of user-defined negotiation elasticity parameters; using an artificial intelligence negotiation agent for: transmitting the vehicle purchasing and configuration information to the plurality of dealers; negotiating with the plurality of dealers, over the information delivery and negotiation exchange cloud and using the plurality of user-defined negotiation parameters and the plurality of user-defined negotiation elasticity parameters, on behalf of but independent from the user, a respective one set of negotiated purchase offer terms for the vehicle from each one dealer of the plurality of dealers; compiling a list of the respective one set of negotiated purchase offer terms for the vehicle from the each one dealer of the plurality of dealers; and transmitting, to the user, the list of the respective one set of negotiated purchase offer terms for the vehicle from the each one dealer of the plurality of dealers.

In a second aspect, a method is provided for negotiating a price on behalf of a consumer among competitive sellers for consumer articles such as automobiles.

In a third aspect, a vehicle price negotiation app may be executed on the user device for executing operations that facilitate accessing the cloud-based system and for the negotiation of the vehicle price from the plurality of dealers using artificial intelligence and/or machine learning means to conduct the negotiation on behalf of and independent of the user.

In a fourth aspect, the vehicle price negotiation app may be facilitated by a user device comprising a mobile application that when executed delivers the operations that facilitate accessing the cloud-based system and for the negotiation of the vehicle price from the plurality of dealers using artificial intelligence and/or machine learning means to conduct the negotiation on behalf of and independent of the user.

In another aspect, the user device may be a mobile device such as a smartphone, laptop computer, tablet and/or wearable device.

In another aspect, the user device may be a stand-alone consumer device such as a kiosk.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level block diagram of a cloud-based system for negotiating a price among competitive sellers for consumer articles such automobiles in accordance with an embodiment.

FIG. 2 presents an illustrative user device configured for use with the cloud-based system of FIG. 1 in accordance with an embodiment.

FIG. 3 presents an illustrative purchasing hosting system for use with the cloud-based system of FIG. 1 in accordance with an embodiment.

FIG. 4 presents an illustrative architecture for a vehicle price negotiation application in accordance with an embodiment.

FIGS. 5A, 5B and 5C presents a flowchart of illustrative operations for negotiating a price among competitive sellers for consumer articles such automobiles using the cloud-based system of FIG. 1 and the illustrative vehicle negotiation application architecture of FIG. 4 in accordance with an embodiment.

FIGS. 6A and 6B present an illustrative user interface for negotiating a price among competitive sellers for consumer articles such automobiles using the cloud-based system of FIG. 1 and the illustrative vehicle negotiation application architecture of FIG. 4 in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the Figures herein. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a cloud-based system, apparatus and method that provide for negotiating a price among competitive sellers on behalf of and independent from a consumer for consumer articles such as automobiles.

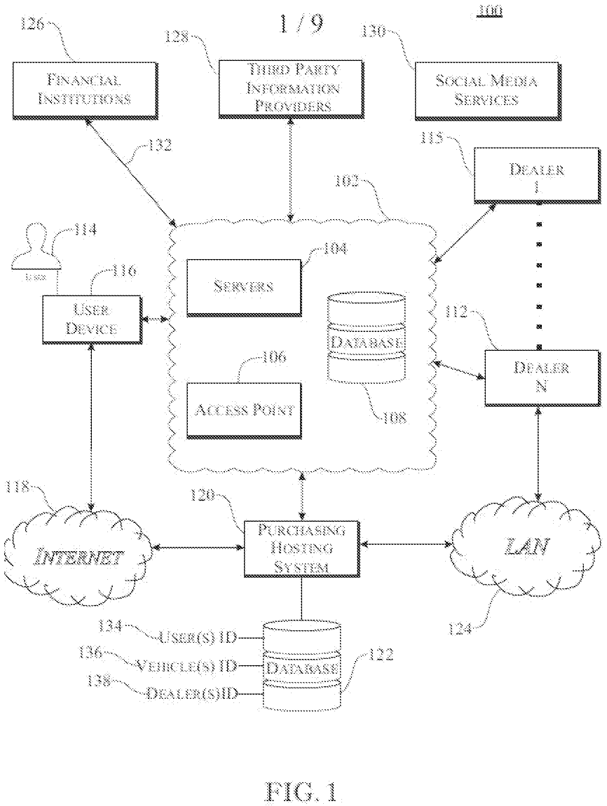

FIG. 1 presents a high-level block diagram of a cloud-based system 100 (i.e., a consumer article price negotiation system) for negotiating a price among competitive sellers for consumer articles such as automobiles in accordance with a first embodiment of the present invention. As shown for instance in FIG. 1, the cloud-based system 100 includes an information delivery and negotiation exchange cloud 102 comprising at least server(s) 104, access point(s) 106 and database(s) 108. As will be detailed herein below, the information delivery and negotiation exchange cloud 102 in accordance with the embodiment facilitates for negotiating a price among competitive sellers for consumer articles such as automobiles through the execution of a vehicle price negotiation application (as detailed further herein below) executing, illustratively, on user device 116 thereby allowing user 114 to obtain a price for a desired vehicle that meets the user’s 114 select criteria including, but not limited to the lowest price from a particular dealer of a plurality of dealers (e.g., the plurality dealers comprised by dealer 1 110 through dealer N 112).

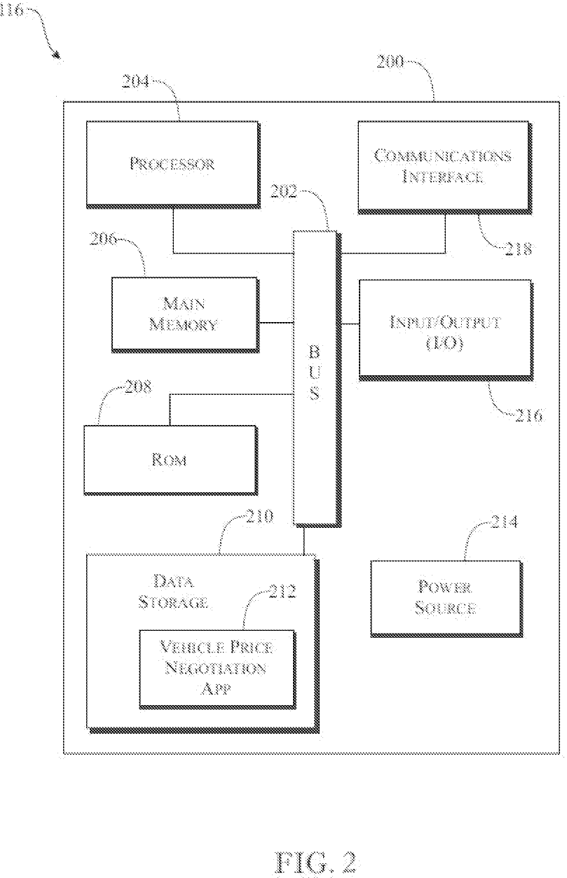

Turning our attention briefly to FIG. 2, an illustrative user device 116 configured as mobile device 200 is shown for deployment with the cloud-based system 100 of FIG. 1 in accordance with an embodiment. The mobile device 200 typically includes bus 202 or other communication mechanism for communicating information and processor 204 coupled to the bus 202 for executing operations and processing information in a well-known manner. As will be appreciated, a “mobile device” in the context herein may comprise a wide variety of devices such as smartphones, laptop computers, tablets, and wearable device, to name just a few, that execute mobile applications in accordance with the principles of the disclosed embodiments herein. For example the execution of the operations of vehicle price negotiation app 212 as will be discussed in much greater detail herein below. The processor 204, as powered by power source 214, may include both general and special purpose microprocessors, and may be the sole processor or one of multiple processors of the user device 116. Further, the processor 204 may comprise one or more central processing units (CPUs) and may include, be supplemented by, or incorporated in, one or more application-specific integrated circuits (ASICs) and/or one or more field programmable gate arrays (FPGAs).

The mobile device 200 may also include main memory 206 coupled to the bus 202 for storing computer-readable instructions to be executed by the processor 204 in a well-known manner. The main memory 206 may also be utilized for storing temporary variables or other intermediate information during the execution of the instructions by the processor 204. The mobile device 200 may also include read-only memory (ROM) 208 or other static storage device coupled to the bus 202. Further, data storage device 210, such as a magnetic, optical or solid state device may be coupled to the bus 202 for storing information and instructions for the processor 204 including, but not limited to, the vehicle price negotiation app 212. Data storage device 210 and the main memory 206 may each comprise a tangible non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVDROM) disks, or other non-volatile solid state storage devices.

The mobile device 200 may also include one or more communications interface 218 for communicating with other devices via a network (e.g., a wireless communications network) or communications protocol (e.g., Bluetooth®). For example, such communication interfaces may be a receiver, transceiver or modem for exchanging wired or wireless communications in any number of well-known fashions. For example, the communications interface 218 may be an integrated services digital network (ISDN) card or modem/router used to facilitate data communications of various well-known types and formats. Further, illustratively, the communications interface 218 may be a local area network (LAN) card used to provide data communication connectivity to a comparable LAN. Wireless communication links may also be implemented. As will be appreciated, the functionality of the communication interface 218 is to send and receive a variety of signals (e.g., electrical, optical or other signals) that transmit data streams representing various data types. The mobile device 200 may also include one or more input/output devices 216 that enable user interaction with the mobile device 200 (e.g., camera, display, keyboard, mouse, speakers, microphone, buttons, etc.). The input/output devices 216 may include peripherals, such as a camera, printer, scanner, display screen, etc. For example, the input/output devices 216 may include a display device such as a cathode ray tube (CRT), plasma or liquid crystal display (LCD) monitor for displaying information to the user, a keyboard, and a pointing device such as a mouse or a trackball by which the user can provide input to the mobile device 200.

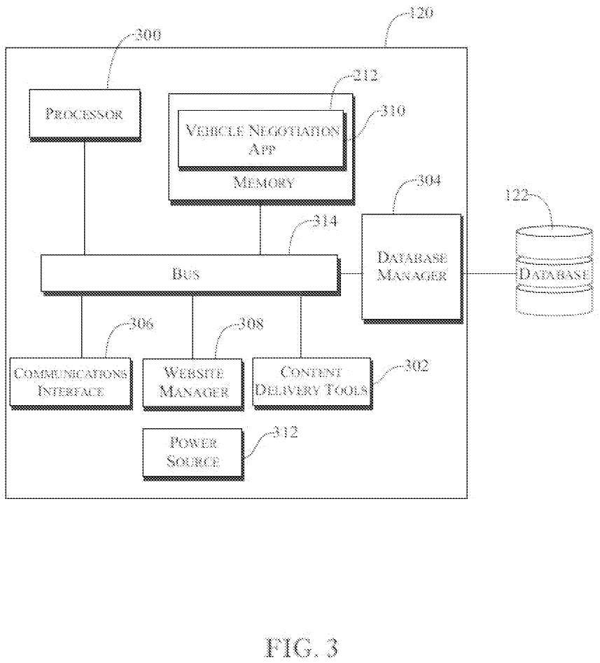

Turning our attention to FIG. 3, an illustrative configuration for the purchasing hosting system 120 (see, FIG. 1) is shown for deployment with the architecture of the cloud-based system 100 in accordance with an embodiment. As shown, the purchasing hosting system 120 comprises processor 300 for executing program code (e.g., vehicle price negotiation app 212) and communications interface 306 for managing communications to and from the purchasing hosting system 120, memory 310 for storing program code and data, and power source 312 for powering the purchasing hosting system 120. The memory 310 is coupled to the bus 314 for storing computer-readable instructions to be executed by the processor 300 (e.g., vehicle negotiation app 212) in a well-known manner. Database manager 304 is used to manage the delivery and storage of content (e.g., user(s) ID 134, vehicle(s) ID 136 and dealer(s) ID 138) in the hosting database(s) 122 in a well-known manner. As will be discussed in greater detail herein below, content delivery tools 302 and the vehicle price negotiation app 212 when executed by the processor 300 will enable access to the user 114 to the cloud-based system 100 for the negotiation of a vehicle price from the plurality of dealers (i.e., dealer 1 110 through dealer N 112) using artificial intelligence and/or machine learning means to conduct the negotiation on behalf of and independent of the user 114. This may also include accessing and interfacing with a variety of third party websites using website manager 308 for procuring information and data that can be used in the vehicle price negotiation process (as discussed further herein below). The term “web site” (or “website”) in the context herein is used in a conventional and broadest sense and is located on at least one server containing web pages stored thereon and is operational in a 24-hour/7 day typical fashion. As shown in the cloud-based system 100, the user 114 may alternatively utilize well-known Internet 118 for access to cloud-based system 100 by and through user device 116 and the purchasing hosting system 120 in a well-understood fashion.

The communications interface 306 is used to facilitate communications across the communications links 132 (see, FIG. 1) with the information delivery and negotiation exchange cloud 102 in a well understand fashion. This may take the form, for example, of a wide area network connection that communicatively couples the purchasing hosting system 120 with the access points 106 (see, FIG. 1) which may be a cellular communications service. Similarly, communications managed by the communications interface 306 may take the form, for example, of a local Wi-Fi network interface or Ethernet interface the communicatively couples the purchasing hosting system 120 with the Internet 118, LAN 124 and ultimately the user device 116. In this embodiment, the vehicle price negotiation app 212 and/or the communications interface 306 may include a communications stack for facilitating communications over the respective communications link 132.

Turning our attention back to FIG. 1, in an embodiment, upon launching and executing vehicle price negotiation app 212 the user 114 is able to access the cloud-based system 100 for the negotiation of a vehicle price from the plurality of dealers (i.e., dealer 1 110 through dealer N 112) using artificial intelligence and/or machine learning means to conduct the negotiation for and independent of the user 114. In this way, the user 114, as will be further detailed below, will provide his/her vehicle choice(s) and information defining the negotiation parameters for use by the vehicle price negotiation app 212 and/or the purchasing hosting system 120 and hosting database(s) 122 and information delivery and negotiation exchange cloud 102 including accessing content from a plurality of facilities and third party content providers including but not limited to social media services 130, financial institutions 126 and third party information providers 128. For example, the social media services 130 may include social media accounts associated with one or more of the plurality of dealers (e.g., dealer 1 110) where such dealer posts certain customer incentives or advertising. As shown, the hosting database(s) 122 store information including but not limited to the user(s) ID 134, the vehicle(s) ID 136 and the dealer(s) ID 138. Electronic communications by and through cloud-based system 100 between the various systems, networks, devices and/or individuals are facilitated by the communications links 132 in accordance with any number of well-known communications protocols and methods (e.g., wireless communications).

As shown, the information delivery and negotiation exchange cloud 102 comprises at the least server(s) 104, the access point(s) 106 and the database(s) 108. Cloud, cloud service, cloud server and cloud database are broad terms and are to be given their ordinary and customary meaning to one of ordinary skill in the art and includes, without limitation, any content database, data repository or storage media which store content typically associated with and managed by users, new and/or used car dealers, third party content providers, social media services, to name just a few. A cloud service may include one or more cloud servers and cloud databases that provides for the remote storage of content as hosted by a third party service provider or operator. A cloud server may include an HTTP/HPTTPS server sending and receiving messages in order to provide web-browsing interfaces to client web browsers as well as web services to send data to integrate with other interfaces (e.g., as executed on the user device 116). The cloud server may be implemented in one or more well-known servers and may send and receive content in a various forms and formats, user supplied and/or created information/content and profile/configuration data that may be transferred to, read from or stored in a cloud database (e.g., the databases 108).

A cloud database may include one or more physical servers, databases or storage devices as dictated by the cloud service’s storage requirements. The cloud database may further include one or more well-known databases (e.g., an SQL database) or a fixed content storage system to store content, profile information, configuration information or administration information as necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools. In this way, in accordance with various embodiments, the users may control and initiate their particular vehicle price negotiation in a fully transparent fashion without any required understanding of the underlying hardware and software necessary to interface, communicate, manipulate and exchange information and/or date to realize the negotiated vehicle price.

Importantly, in accordance with the embodiments herein, the vehicle price negotiation app 212 comprises artificial intelligence (AI) and/or machine-learning techniques that are applied to facilitate the real-time and independent (from the user) negotiation of the optimal vehicle price as received from negotiating and interfacing with a plurality of dealers willing to fulfill the sale request. As will be understood, in computer science AI (sometimes also referred to as machine intelligence) is intelligence demonstrated by a machine in contrast to the natural intelligence displayed by humans and animals. Typically, AI defines the field as the study of so-called “intelligent agents” that are any device that perceives its environment and takes actions that maximize its chance of successfully achieving its goals. Colloquially speaking, the term “artificial intelligence” is often used to describe machines (or computers) that mimic “cognitive” functions that humans associate with the human mind such as “learning” and “problem solving”. As will be appreciated there exist a variety of artificial intelligence and machine learning models that may by used to enable the real-time negotiation aspects of the disclosed embodiments such algorithmic models include: linear regression, logistic regression, linear discriminant analysis, decision trees, naive bayes, K-nearest neighbors, learning vector quantization, support vector machines, random forest, and deep neural networks.

Machine learning is one of the applications of AI where machines are not explicitly programmed to perform certain tasks rather they learn and improve from experience automatically. Deep learning is a subset of machine learning based on artificial neural networks for predictive analysis. There are various machine-learning algorithms such as unsupervised learning, supervised learning, and reinforcement learning. In unsupervised learning, the algorithm does not use classified information to act on it without any guidance. In supervised learning, it deduces a function from the training data that consists of a set of an input object and the desired output. Reinforcement learning is used by machines to take suitable actions to increase the reward to find the best possibility that should be taken in to account. Further, natural language processing (NLP) encompasses the interactions between computers and human language where the computers are programmed to process natural languages and learn therefrom. Machine learning is a reliable technology for natural language processing to obtain meaning from human languages. In NLP, the audio of a human talk is captured by the machine. Then the audio to text conversation occurs and then the text is processed where the data is converted into audio. Then the machine uses the audio to respond to humans, for example. Applications of NPL can be found in interactive voice response (IVR) applications used in call centers, language translation applications like Google Translate and word processing applications to check the accuracy of grammar in text. However, the nature of human languages makes the natural language processing difficult because of the rules that are involved in the passing of information using natural language and they are not easy for the computers to understand. So NLP uses algorithms to recognize and abstract the rules of the natural languages where the unstructured data from the human languages can be converted to a format that is understood by the computer.

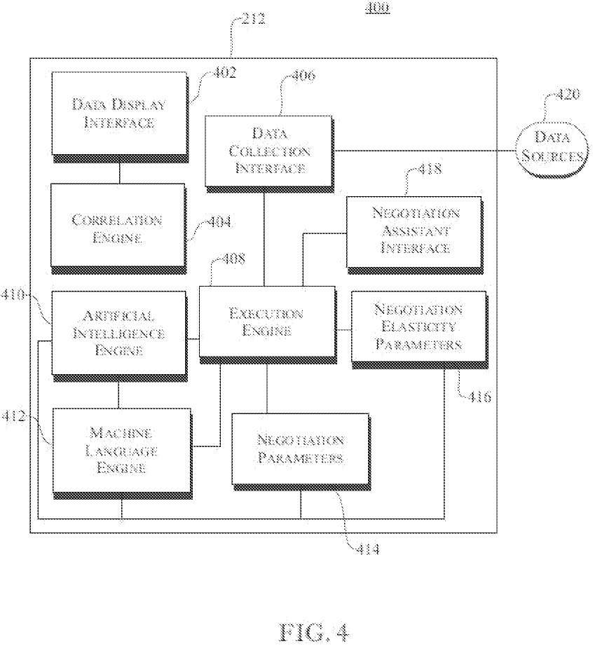

Turning our attention to FIG. 4, an illustrative architecture 400 for the operation of the vehicle price negotiation app 212 is presented in accordance with an embodiment. As will be appreciated, the architecture 400 may be used in conjunction with user device 116 for launching and executing the vehicle price negotiation application 212 and its associated operations. As shown, the vehicle price negotiation app 212 provides several interfaces and engines used to perform a variety of functions such as the collection, aggregation, manipulation, processing, analyzing and display of applicable real-time information and data necessary to achieve the real-time negotiation of the optimal price thereof across the plurality of dealers bidding, as will be further detailed herein below. More particularly, data display interface 402 and the negotiation assistant interface 418 are used to facilitate the output and display of electronic data (e.g., a graphical user interface) to the user 114 employing the user device 116 (e.g., a touch screen of the mobile device 200) and executing the vehicle price negotiation app 212. Correlation engine 404 is used to correlate the information received, as collected by data collecting interface 406, from active third party sources (e.g., the dealer 1 110 through the dealer N 112, the third party information providers 128 and/or the social media services 130). The data collecting interface 406 may also be used to collect real-time product (e.g., vehicle) information from other virtual and/or electronic sources (i.e., data sources 420) such as the Internet 118 and individual third party web sites hosted thereon.

Execution engine 408 may be employed to aggregate and/or process information from the data collection interface 406, negotiation parameters 414, negotiation elasticity parameters 416, artificial intelligence engine 410 and/or machine learning engine 412. The artificial intelligence 406 and the machine learning engine 412 may be employed to deliver one or more of the aforementioned AI and/or machine learning techniques employed in the disclosed embodiments, consistent with the negotiation parameters 414 and negotiation elasticity parameters 416 as received from the user 114, to facilitate the real-time and independent (from the user) negotiation of the optimal vehicle price as received from negotiating and communicating with a plurality of dealers willing to fulfill the sale request.

As noted above, while FIG. 2 describes an embodiment the vehicle price negotiation app 212 being executed on the mobile device 200 it will also be understood that other hardware devices may be used to execute and operate the vehicle price negotiation app 212 in any real-time setting. For example, a network-enabled portable tablet computer and/or dedicated portable hardware device may be employed equally in the context of the disclosed embodiments. Alternatively, a fixed-location device or system (e.g., a free standing kiosk) may be used to interact with and be accessible to the user 114 in a variety of ways and locations to allow for the real-time and independent (from the user) negotiation of the optimal vehicle price as received from negotiating and interfacing with a plurality of dealers willing to fulfill the sale request.

As noted above, the artificial intelligence engine 410 and the machine learning engine 412 may be employed to deliver one or more of the aforementioned AI and/or machine learning techniques, consistent with the negotiation parameters 414 and negotiation elasticity parameters 416 as received from the user 114, to facilitate the real-time and independent (from the user) negotiation of the optimal vehicle price as received from negotiating and interfacing with a plurality of dealers willing to fulfill the sale request. In essence, the artificial intelligence engine 410 and/or the machine learning engine 412 define an Al-framework such that a “negotiation assistant” in the form of an AI agent (or agents) will negotiate on behalf of the user 114 to obtain the optimal price for the desired new or used car purchase. In this way, the user 114 may find and communicate with dealers (e.g. dealer 1 110 through dealer N 112) through the negotiation agent using the detailed framework herein in an optimized fashion that incorporates various aspects of a purchasing transaction to be negotiated and parameters adjusted in real-time. Further, the artificial intelligence engine 410 and/or the machine learning engine 412 may use natural language processing and learning to comprehend the various offers received from the contacted dealers and execute a negotiation process specific to each dealer to leverage the negotiation with that particular dealer.

As described herein, the AI agent (alternatively referred to herein as an “Al bot” or “AI negotiation agent”) will be used to locate the desired vehicle on the open marketplace and negotiate offer terms on behalf of (and independent from) the user 114. That is, the AI agent is aware of the user’s 114 vehicle type selection, budget, requirements, preferences and other parameters (i.e., the negotiation parameters 414) including the negotiation elasticity parameters 416. Further, the user 114 may also define a weighting associated with one or more of the negotiation parameters 414 and/or the negotiation elasticity parameters 418. For example, the user 114 may indicate parameters specifying that the purchase price may not exceed a set number, and the deliver dates are flexible but the purchase of the vehicle must be made and not delayed. As such, a low, medium and high ranking is assigned accordingly. Importantly, the real-time negotiation carried out by the AI agent, by and through the execution of the vehicle price negotiation app 212 and utilizing the artificial intelligence engine 410 and/or machine-learning engine 412, is performed autonomously from the user 114. Further, advantageously, the vehicle price negotiation app 212 facilitates the use of the AI agent to contact multiple (in large numbers of and geographically dispersed, for example) based on a variety of user-defined parameters including but not limited to proximity to the user, and vehicle preferences, to name just a few, and also using information retrieved from a plethora a publicly available sources. Further, the AI agent builds its knowledge base from each transaction thereby increasing the AI agent’s negotiation abilities to extract the best (e.g., the lowest) price on the particular consumer article (e.g., a vehicle). For example, in one negotiation scenario there may be severe weather conditions (e.g., a blizzard) impacting a particular geographic region in the United States (e.g., the northeast corridor) thereby adversely impacting and depressing customer traffic and vehicle sales in that region. The AI agent herein, and in accordance with the disclosed embodiments, will leverage these known weather conditions to target dealers in the affected area knowing that such dealers may have more of an incentive to offer a lower price than other dealers in an attempt to generate sales.

Of course, the embodiments herein are focused on a motor vehicle purchase but the principles of the disclosed embodiments apply to any product and may also extended to services (e.g., vehicle repairs, communication services, food services, bank loans, insurance rates and policies, leasing, etc.). Similarly, the embodiments herein are focused on the user 114 and their purchase activity (i.e., the “buy” side of the transaction) but the principles of the disclosed embodiments are equally applicable to the “sell” side of the transaction and to the seller (e.g., the dealer 1 112 through the dealer N 112) and negotiation parameters that are specific to the seller.

As referred to herein, “elasticity” means the difference in one or more of the negotiation parameters 414 as determined by the user 114 as defined by an upper and lower limit for the particular negotiation parameter. For example, the user 114 may have specified their desire that any final purchase price be in the range of $50,000 to $65,000 thereby setting the threshold for the purchasing decision by the AI agent. Of course, any or all of the negotiation parameters 414 may be elastic and subject to the negotiation elasticity parameters 416. Further, the negotiation elasticity parameters 416 may be set or influenced by current market conditions, vehicle availability, deliver conditions, warranties, seasonality market trends, product reviews, financial conditions or any other parameters germane to a product/service pricing negotiation context between a buyer and seller.

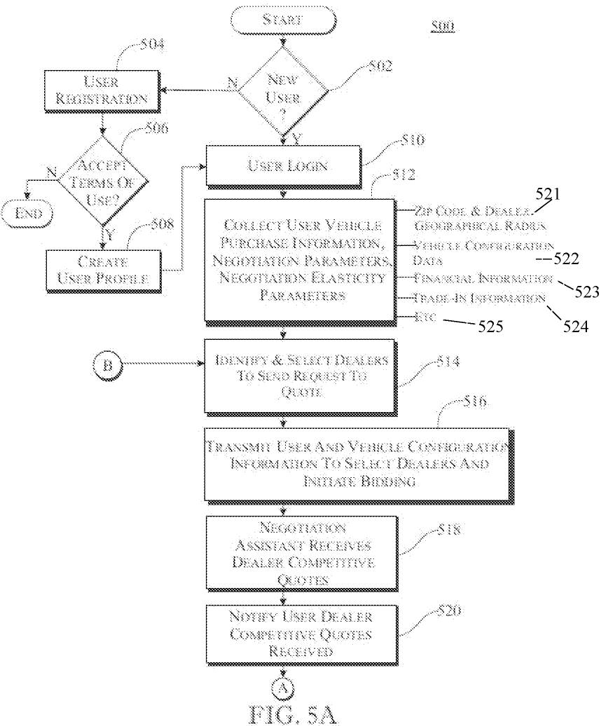

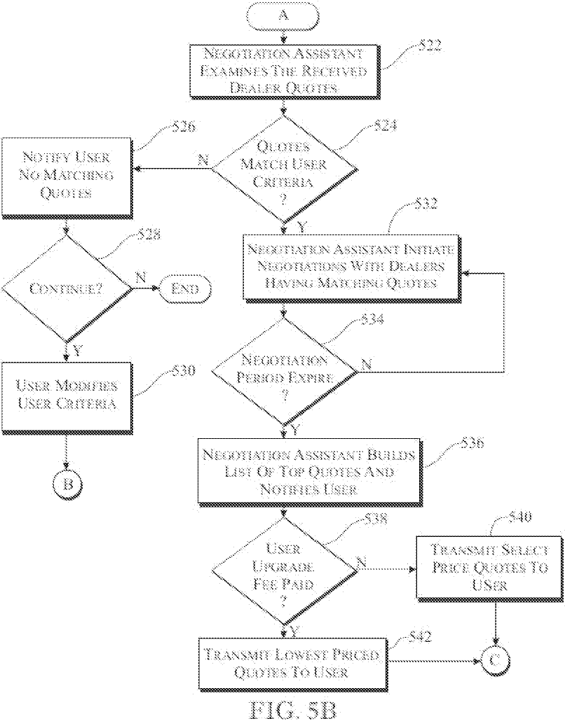

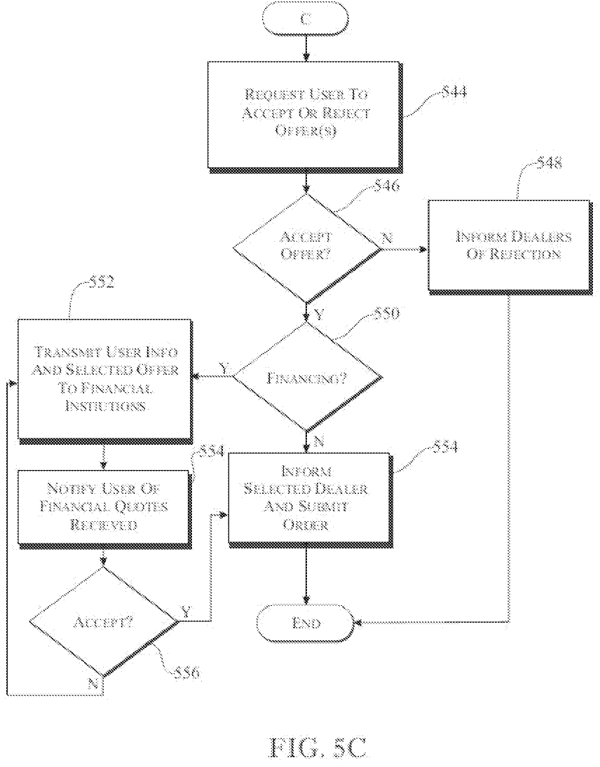

In FIGS. 5A-5C, a flowchart of illustrative operations 500 is shown for the real-time and independent (from the user) negotiation of the optimal vehicle price as received from negotiating and interfacing with a plurality of dealers willing to fulfill the sale request using the cloud-based system of FIG. 1 in accordance with an embodiment. In accordance with the operations 500 of FIG. 5A that begin in step 502, a determination is made whether the user (e.g., user 114) is a new or an established user, and if a new user then a standard user registration procedure at step 504 is executed with an affirmation of acceptance of the terms of use at step 506. If the user agrees, then a user profile (e.g., name, address, contact information, etc.) is created at step 508. Otherwise, the procedures terminate. At step 510, a user login procedure ensues. As will be appreciated, such login procedure may include entering a user name and password (and second factor authentication) specific to the registered user. At step 512, collection of the user vehicle purchase information (e.g., dealer geographical radius based on zip code, vehicle configuration data, financing information, trade-in information, etc.), the negotiation parameters (e.g., the negotiation parameters 414) and the negotiation elasticity parameters (e.g., the negotiation elasticity parameters 416) is executed. Illustratively, at step 514, the operations carried out by (and on behalf of but independent from the user) the negotiation assistant (including the application and execution of the above-detailed AI and/or machine learning techniques and associated algorithms) begin with identifying and selecting the dealers (e.g., dealer 1 110 through dealer N 112) and sending a request to quote/offer for the desired vehicle. At step 516, transmitting the user and vehicle configuration information to the select dealers is completed and the bidding and negotiations initiated therefrom. As step 518, the negotiation assistant receives the individual competitive quotes from the selected dealers and, at step 520, notifies the user of the receipt of the individual competitive quotes.

At step 522 (see, FIG. 5B) the negotiation assistant examines the received dealer quotes and determines, as step 524, if any of the received quotes (or offers) match the user-specified criteria. If not, at step 526, the user is notified that there were no matching quotes and a determination is made, at step 528, if the user wants to continue. If not, the operations end and if so, the user modifies the user-specified criteria at step 530 and the operations return again to step 514 in accordance with such modified user-specified criteria. When matching quote(s) are determined at step 524, the negotiation assistant initiates negotiations (in accordance with the negotiation parameters 414 and the negotiation elasticity parameters 416, as detailed above) with the dealers associated with the matching quotes. At step 534, a determination is made as to whether the negotiation period (e.g., one hour) has expired and if not, the negotiations continue at step 532. Otherwise, at the expiration of the negotiation period, the negotiation assistant builds, at step 536, a list of the top (i.e., most desirable) quotes (or offers) associated with their respective dealer and notifies the user accordingly. At step 538, a determination is made as to whether the user has selected to receive and paid the fee for a premium service to receive the lowest priced quote(s) negotiated by the negotiation assistant and, if so the lowest priced quote(s) are transmitted to the user at step 542 and the operations proceed accordingly. Otherwise, at step 540, the negotiation assistant transmits a selection (but not necessarily all or the lowest/best) of the price quotes for the list build by the negotiation assistant and the operations proceed accordingly.

At step 544 (see, FIG. C), a request is sent to the use to accept or reject the offer(s) and a determination is made, at step 546, whether one of the offers has been selected by the user and, if not, the dealers are informed accordingly at step 548 and the operations end. Otherwise, if the user has selected one of the offers, a determination is made, at step 550, as to whether the user needs financing (e.g., a car loan or car leasing terms) and, if not, the selected dealer is informed of the user’s acceptance of their offer and the order is submitted, at step 558. If the user requires financing, then the user’s information and selected dealer offer are transmitted to a variety of financial institutions for quotes at step 552. Importantly, the negotiation assistant operations as detailed herein above, modified for this financial application, may be used for the independent negotiation of the financial terms by the AI bot in accordance with an embodiment. Further, in another embodiment, the AI bot operations may be modified such one of more of the dealers utilize the negotiation assistant operations to negotiate the car sale price on their behalf. In such embodiment, both the user and the dealer interests are represented by and through a respective AI bot such that the negotiation occurs independent from and without intervention by either the user or the dealer. At step 554, the user is notified of the received financial quotes as negotiated and received from the financial institution and, at step 556, a determination is made if one of the financial quotes is acceptable. If not, the operations return to step 552 for additional processing and receipt of further financial quotes. If a financial quote is accepted, as indicated as step 556, then the selected dealer is informed, at step 558 that their offer has been selected and the order submitted together with any financing details.

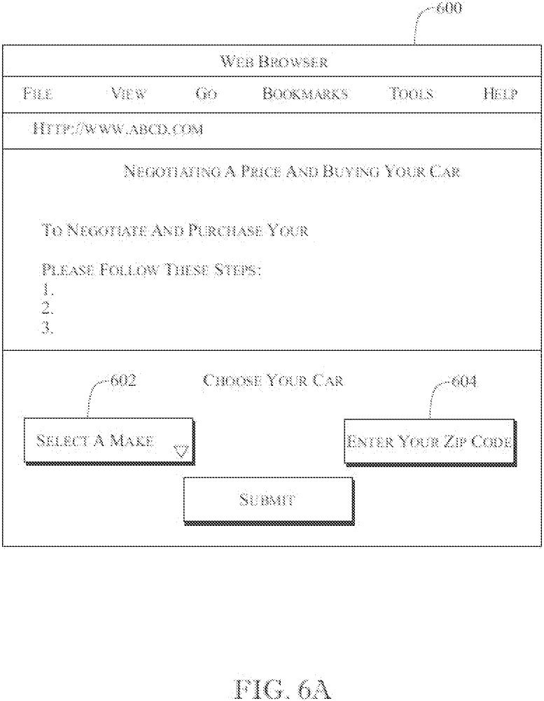

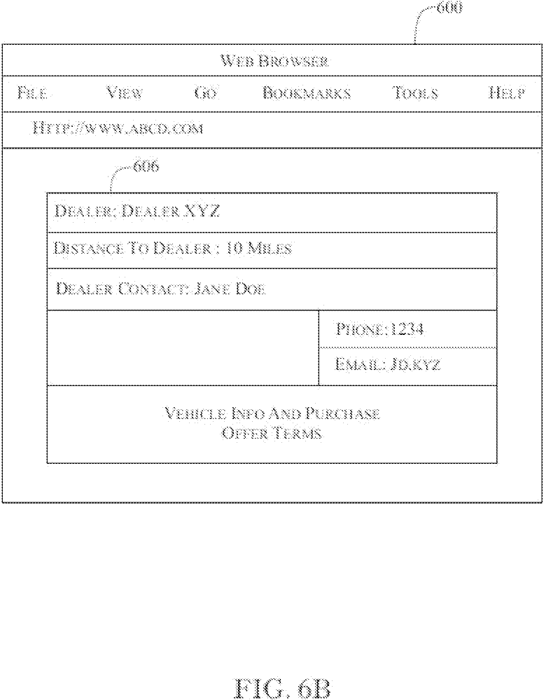

FIGS. 6A and 6B present an illustrative user interface for negotiating a price among competitive sellers for consumer articles such automobiles using the cloud-based system of FIG. 1 and the illustrative vehicle negotiation application architecture of FIG. 4 in accordance with an embodiment. As shown in FIG. 6A, vehicle selection and negotiation interface 600 is provided illustratively by and through execution of the vehicle negotiation app 212, as detailed herein above. The user 116 through the vehicle selection and negotiation interface 600 is able to select and price the desired vehicle and locate an acceptable participating dealer by entering the desired vehicle make/model at input area 602 and a zip code associated the user 116 as indicated at input area 604. Thereafter, as detailed herein above, the illustrative operations 500 are executed for the real-time negotiation, on behalf of and independent from the user, of the optimal vehicle price as received from negotiating and interfacing with the plurality of dealers willing to fulfill the sale request using the cloud-based system 100 in accordance with the embodiment. As shown in FIG. 6B, upon the negotiation assistant completing the vehicle price negotiation (and financial loan or lease negotiation in the further embodiment detailed herein above) the dealer and price selected by the user 116 is displayed, as indicated at output area 606, together with the selected dealer contact information for use by the user 116.

As noted above, in some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method (see, e.g., FIGS. 5A-C) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

1. A system for reaching elasticity-based numerical agreement between a plurality of user devices, the system comprising:
a network-connected information delivery and exchange computer comprising a processor, one or more databases, a memory, and a plurality of programming instructions, the plurality of programming instructions stored in the memory that when executed by the processor cause the processor to:
receive a plurality of connections from a plurality of user devices wherein a portion of the plurality of user devices are dealer devices;
receive, from a first user device, configuration information associated to a first article;
receive a plurality of user parameters and user-elasticity parameters from the first user device, the user parameters comprising, at least, a maximum numeric value and a timeframe;
receive, from the first user device, a plurality of weightings for the plurality of user parameters;
transmit the configuration information and the user parameters to at least a subset of dealer devices;
receive a plurality of numeric terms from at least a portion of the subset of dealer devices, the numeric terms associated to the article and based on the user parameters, the at least a portion of the subset of dealer devices based on the user parameters;
display the plurality of numeric terms on the graphical user interface of the first user device;
receive, from the user device, adjustments to the user parameters to determine an optimal set of numerical agreement, the optimal set of numerical agreements based on the user parameters, the plurality of weightings, and user elasticity;
compile a ranked list from the plurality of numeric terms, the ranking of the list based on the optimal set of numerical agreements;
transmit, to the graphical user interface of the first user device, the ranked list.
